(19) United States
(12) Patent Application Publication
(10) Pub. No.: US 2018/0219755 A1
(43) Pub. Date: Aug. 2, 2018

(54) DETERMINATION OF STATUS OF PORTS IN STORAGE AREA NETWORKS

(71) Applicant: Hewlett Packard Enterprise Development LP, Houston, TX (US)

(72) Inventors: Vivek Agarwal, Marlborough, MA (US); Rupin Mohan, Northborough, MA (US); Krishna Puttagunta, Rocklin, CA (US)

(21) Appl. No.: 15/422,558

(22) Filed: Feb. 2, 2017

(51) Int. Cl. H04L 12/26; H04L 29/08; H04L 12/947; H04L 12/24

(52) U.S. Cl. CPC H04L 43/08; H04L 67/1097; H04L 41/0659; H04L 41/14; H04L 49/25

(57) ABSTRACT

Examples described herein relate to determining a health status of a storage area network (SAN) port by a SAN target. In some such examples, a method includes identifying, by the SAN target, a target port of the SAN target. The SAN target retrieves, from a SAN switch, a set of peer zones for which the target port is a principal member. The SAN target retrieves from the SAN switch a set of end-device ports that are associated with the set of peer zones, and the SAN target determines a status of a given end-device port of the set of end-device ports.

### BACKGROUND

A Storage Area Network (SAN) plays a critical role in a modern data center by providing connectivity between any number of target storage devices and host computing devices over a dedicated network. The SAN provides block-level data storage and enables for a host the illusion of direct connectivity with any targets to which it has access. A SAN maps a SAN path from a host device to a target device, such as a storage array, via one or more switches that make up one or more SAN fabrics. Thus, a SAN infrastructure includes SAN devices such as hosts, targets, and switches, including SAN components such as processors, controllers, ports, and transceivers that are physically coupled or otherwise associated with such SAN devices.

### BRIEF DESCRIPTION OF THE DRAWINGS

Certain examples are described in the following detailed description with reference to the drawings, of which:

FIG. 1 is a block diagram of a computing environment, according to some examples of the present disclosure.

FIG. 2 is a flow diagram of a method of determining a health status of a SAN port by a SAN target, according to some examples of the present disclosure.

FIG. 3 is a flow diagram of a method of detecting a failing transceiver of a SAN port by a SAN target, according to some examples of the present disclosure.

FIGS. 4A-4B are block diagrams of a computing environment performing a method of determining a health status, according to some examples of the present disclosure.

FIGS. 5A-5B are block diagrams of a computing environment performing a method of detecting a failing transceiver, according to some examples of the present disclosure.

FIGS. 6-7 are diagrams of SAN commands, according to some examples of the present disclosure.

FIG. 8 is a block diagram of a processing resource including a non-transitory computer-readable storage medium, according to some examples of the present disclosure.

FIG. 9 is a block diagram of a SAN target including a computer-readable storage medium containing executable instructions, according to some examples of the present disclosure.

### DETAILED DESCRIPTION

A storage area network (SAN) provides for communications of data and/or other in-band management traffic to flow between a target device and a host device, such that the two SAN devices are communicatively connected via one or more SAN paths over a SAN fabric. The SAN fabric joining the two SAN devices may include one or more switches that route the communications between the target and the host along a SAN path and that procedurally enforce the SAN path as configured and pursuant to networking protocols. The SAN path may include a set of SAN ports, including a port of the host, a port of the target, and the ports of the one or more switches through which the communications route between the host port and the target port. In several examples of the present disclosure, each SAN device has one or more SAN ports that communicatively connect to the SAN fabric, and each SAN port has a corresponding transceiver to route the communications over the SAN fabric. Each port may communicatively connect to another port via one-to-one correspondence. In-band management traffic may flow between SAN devices using the same network as the data that is routed in the network via networking protocols.

Several different protocols for packet transmission have been developed for use in a SAN fabric through currently available SAN deployments, including for example Fibre Channel (FC), Fiber Channel over Ethernet (FCoE), and internet Small Computer System Interface (iSCSI). Thus, diagnostic services for protocol-agnostic SAN infrastructure may be critical to efficient systems management in a modern data center. Diagnostic services may be used in a SAN to maintain system availability, to isolate faults in system recovery, to verify system integrity, and/or to increase system reliability.

A SAN may develop various issues with respect to connectivity over the network. For example, a SAN fault may develop for various reasons, including hardware failure or optical link failure, and may lead to network performance problems, system downtime, and/or other significant expenses. In some such examples and particularly for a SAN of large scale with respect to devices or connections, a SAN fault may demand time and interaction to isolate and to resolve.

Many examples in the present disclosure provide a method of diagnostic analysis within a SAN fabric by using a SAN target to determine a health status of a SAN port. In some such examples, the target communicates via in-band management traffic with a switch that connects the target to a SAN fabric in response to an event occurring on the SAN fabric. The event may be an initialization preceding a configuration of the SAN fabric and/or a fault during a runtime of the SAN fabric. In many such examples, the target retrieves zoning information and/or diagnostic parameters from a switch. The target may use a first command to retrieve from the switch a set of peer zones for the target, wherein each peer zone includes a set of host ports and switch ports that have permission to communicate with a port of the target. The target may use a second command to retrieve from the switch a set of diagnostic parameters for each port and/or port component that has permission to communicate with it. For example, the target may thereby retrieve from the switch the diagnostic parameters for each transceiver that has permission to communicate with the target. In several examples of the present disclosure, the target determines a health status of a SAN port based on the diagnostic parameters. The SAN port may be a SAN port not directly connected to the SAN target. In some such examples, wherein a target has determined that a SAN port and/or corresponding transceiver is in a fault state, the target takes various corrective actions. For example, the target may determine a transceiver to be in a fault state, and in response the target blocks transmission by the transceiver over the SAN fabric.

In such examples, the SAN target may thereby receive the set of diagnostic parameters in-band during SAN runtime and while processing data and/or other in-band management traffic, because the communications of the target with the switch may occur via in-band management traffic. In such examples, the target may analyze and diagnose the full, end-to-end SAN fabric to perform a port diagnostic analysis on end-device ports including ports to which the SAN target is not directly connected, because the switch may identify the relevant set of end devices and retrieve the set of diagnostic parameters without the target having direct communication with the end devices. The end devices with relevant and diagnosable end-device ports may include any of the SAN devices of the SAN, such as a host, a target, and/or a switch device. This method benefits SAN system availability and performance stability, for example by enabling a SAN target to predict a failing SAN component and/or to isolate a faulty SAN component without system downtime or manual user interaction. In these ways and others, the method of the present disclosure as described by the examples herein may operate to improve computer network operations and efficiency.

The examples of the present disclosure are described with reference to the following figures. Unless noted otherwise, the figures and their accompanying description are non-limiting, and no element is characteristic of any particular example. In that regard, features from one example may be freely incorporated into other examples without departing from the spirit and scope of the present disclosure.

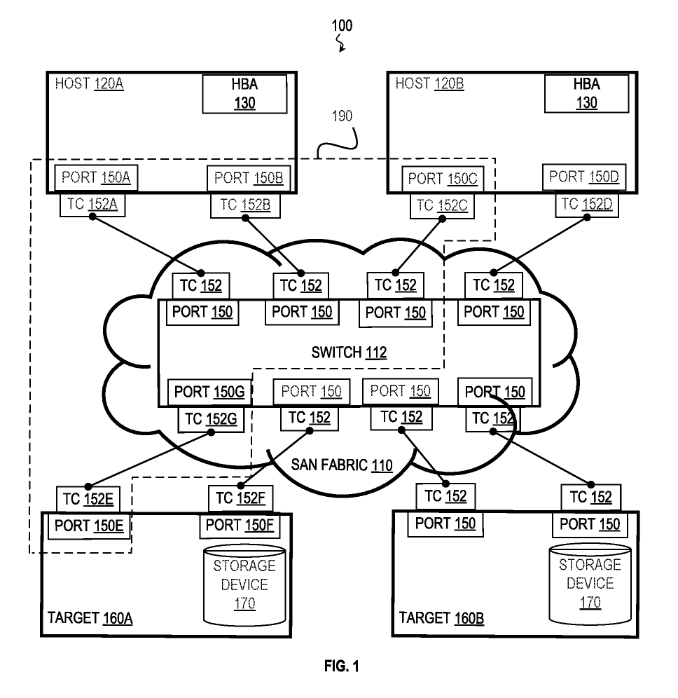

A computing environment for practicing the method of the present disclosure is described with reference to FIG. 1. In that regard, FIG. 1 is a block diagram of a SAN computing environment 100, according to some examples of the present disclosure. The SAN computing environment 100 includes a SAN fabric 110 of any size and configuration of SAN hardware. The SAN fabric 110 may include interconnecting cables, such as fiber optic cables, and may connect any number of computing devices through any suitable switching technology, such as FC, FCoE, or iSCSI. The SAN fabric 110 may include a combination of computing and/or networking entities. The SAN fabric 110 may include a number of switches 112 and any other network devices of any suitable type, configuration, and protocol, such as FC, FCoE, iSCSI, etc., from any vendor or manufacturer. The switches 112 may be any suitable type of network switches that may be used to implement features of communication, security, and/or administration over the SAN fabric 110.

The hosts 120 (including host 120A and host 120B) illustrate suitable computing devices of any size and configuration that may connect to the SAN fabric 110, for example to initiate a session and/or to send a request for service. The hosts 120 may operate as any of servers, clients, workstations, and/or other suitable computing devices. While illustrated as a single entity, each host 120 may include a single unitary computing device, a cluster of discrete computing devices, or any permutation thereof, and in various examples, hosts 120 take various forms including servers, desktop computers, laptop computers, tablets, smartphones, cellular phones, other portable devices, and/or other suitable forms. The hosts 120 connecting to the SAN fabric 110 may be communicatively coupled by routing devices of the network, e.g., the switches 112 and/or other devices such as hubs, bridges, etc. Each host 120 may include a host bus adapter (HBA) 130, host controller, or other host adapter hardware capable of managing communication over the SAN fabric 110. An HBA 130 may communicatively couple any suitable application or product endpoint to the SAN and may provide for utilities to initiate a network session, transmit commands, and/or manage network input and output. A host 120 may serve as an initiator within the SAN via its HBA 130 when it initiates a network session or sends communications, including commands. Each host 120 may include any other devices suitable to the type of computing device, such as a processor to manage system input and output, a memory to store and load data, and/or a user interface to receive commands and/or display information.

The ports 150 (including the ports 150A through 150F) illustrate suitable ports of any size and configuration that may communicatively connect a SAN device to the SAN fabric 110, including for each of the illustrated hosts 120, switches 112, and targets 160. Each SAN device may have one or more ports 150. Each port 150 may have an associated unique identifier within the SAN fabric 110. For example, a world-wide port number (WWPN) is a unique identifier of a port 150, such as a sixteen-byte number encoded by a vendor of the corresponding SAN device. A SAN switch 112 may identify ports 150 and corresponding SAN devices by reference to WWPNs or other suitable port identifier.

The transceivers (TC) 152 (including transceivers 152A through 152F) may connect with the ports 150. Each port 150 may have a transceiver 152 component in a one-to-one correspondence. The transceivers 152 illustrate suitable transceivers of any size and configuration that may route communications over the SAN fabric 110. The transceivers 152 may include small form-factor pluggable (SFP) transceivers.

Similarly to the hosts 120, the targets 160 illustrate suitable computing devices of any size and configuration that may connect to the SAN fabric 110, for example to receive a session request and/or to respond with service during a session. The targets 160 may operate as any of servers, storage systems, storage arrays, and/or other suitable storage devices. While illustrated as a single entity, each target 160 may include a single unitary computing device, a cluster of discrete computing devices, or any permutation thereof. The targets 160 connecting to the SAN fabric 110 may be communicatively coupled by routing devices (e.g., routers, switches, hubs, gateways, etc.) that route any suitable type of packet through the SAN fabric 110, according to any suitable network protocol. Each target 160 may include one or more storage devices 170 capable to be associated with and accessed by the HBA 130 during a network session. Each storage device 170 may be a suitable data storage device of any type, format, and configuration, including flash medium, disk array, and/or magnetic tape. Each target 160 may include any other devices suitable to the type of storage device, such as a storage controller to manage the storage device 170.

The SAN fabric 110 may provide for a dedicated network of any number of interconnected SAN devices, such as the switches 112. The SAN fabric 110 may connect to any number of SAN devices, such as the hosts 120 and the targets 160. In many examples of a SAN and particularly in those with SAN fabrics 110 having a larger scale, a zoning configuration may provide for scaling efficiencies in SAN management services. Zoning may group a set of ports 150 into a zone 190 to restrict or block communications between any ports 150 that are not members of the same zone 190. A peer zone 190 may further designate a port 150 as a principal member within a zone 190, to restrict or block communications between any ports 150 other than a principal member port 150 and a non-principal member port 150 within the same zone 190. With reference to FIG. 1, the host port 150D of host 120B is not in the illustrated peer zone 190 and thus may not communicate over the SAN fabric 110 with the port 150E of the target 160A, which is in the peer zone 190. Yet any SAN device, including a host 120, target 160, or switch 112 may belong to one or more zones 190 simultaneously and may have one or more SAN paths to communicate via one or more ports 150. With respect to FIG. 1, the illustrated peer zone 190 includes the three host ports 150A, 150B, and 150C as illustrated, such that these ports 150 have permission to communicate with the target port 150E of the peer zone 190. Thus, the host 120B may still communicate with the target 160A via host port 150C to target port 150E respectively, because its host port 120C is in the peer zone 190.

In several examples of a SAN computing environment 100, a “smart SAN” fabric 110 may include switches 112 that also enable target-driven peer zoning, or smart SAN zoning, by which a target 160 may itself communicate with a switch 112 to configure a peer zone 190 of the set of host ports 150 and switch ports 150 that have permission to communicate with a port 150 of the target 160. Target-driven zoning may automate some zoning administration, because a target 160 may be caused to configure a target-driven peer zone 190 in response to a predetermined event on the SAN fabric 110. In some examples, a target 160 configures such a peer zone 190 in response to a configuration event of a new zone, such as a host-based zone including the target 160. Similarly, in some examples, a target 160 configures such a peer zone 190 in response to a host 120 being granted permission to communicate with the target 160 via a third-party interface manager, such as 3PAR StoreSery Management Console (SSMC).

The switch 112 may have utilities to administer zoning for a SAN fabric 110. The switch 112 may respond to a set of administrative commands, which may in some examples originate through a user command line interface (CLI). The switch 112 may communicate any administrative changes to other switches 112 of the SAN fabric 110. Among several other example commands, the set of commands may include one or more commands that cause the switch 112 to enable or disable a zoning configuration, to configure or to erase a zone, to display a set of diagnostic parameter for a SAN device such as a switch 112 or for a device component such as a port 150, and to enable or disable a particular feature or runtime operation of a SAN port 150. The switch 112 may include a non-transitory computer-readable storage medium, such as a switch database, in which it may store the zoning information, including identifiers for a set of ports 150 and a set of peer zones 190 associated with each port identifier. In several examples of a SAN computing environment 100 and in particular of a smart SAN fabric 110, the switch 112 enforces zoning by checking communications for routing against its stored information, such that the switch 112 is capable to retrieve for the target 160 the set of peer zones 190 for which an identified target port 150 is a principal member, the set of end-device ports 150 that are member ports of these peer zones 190 and thus in communication with the identified target port 150, and the SAN devices and/or device components, such as transceivers 152, that are related to each port 150 of the relevant set of ports 150. The target 160 may then request the switch 112 to provide one or more diagnostic parameters for each end-device port 150 and/or related device component. As noted above, an end-device port 150 may be a port 150 of any SAN device, such as a host 120, a switch 112, or a target 160. The switch 112 may also obtain this information from one or more end devices related to each port 150 of the set, such as by polling the end device(s). Based on the set of diagnostic parameters received, the target 160 may determine a health status for each port 150 and/or SAN component of the set and implement an action in response, such as blocking transmission via a transceiver 152 determined to be in a fault state.

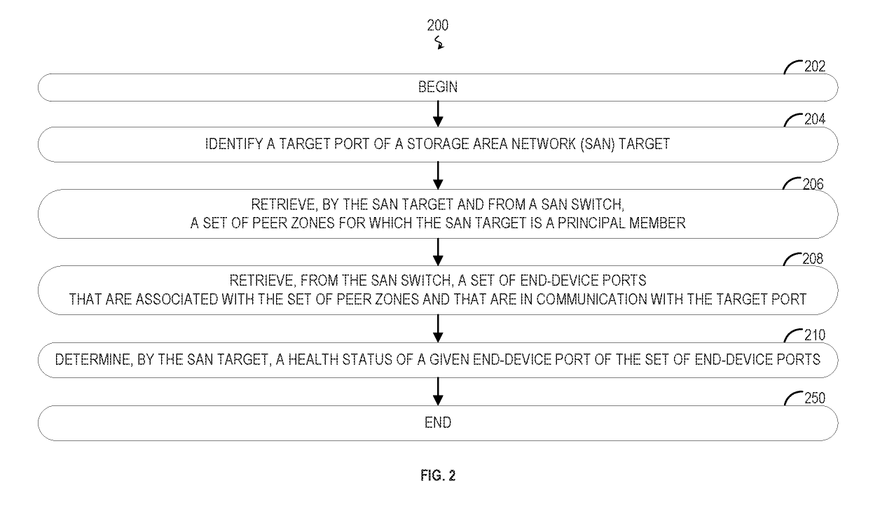

Examples of the method for implementing a diagnostic analysis by using a SAN target 160 to determine a health status of a SAN port 150 is illustrated with reference to FIG. 2. In that regard, FIG. 2 is a flow diagram of a method 200 for a SAN target 160 to determine a health status of a SAN port 150, according to some examples of the present disclosure. It is understood that the description of method 200 is non-limiting, and steps may be added to and omitted from the method 200 without departing from the disclosure. Unless noted otherwise, processes of the method 200 may be performed in any order including concurrently by one or more entities. In general, the method 200 is equally suitable for performance using the SAN computing environment 100 of FIG. 1, or any other suitable computing environment.

The method 200 begins in block 202. In block 204, the target 160 identifies a port 150 of the target 160. For an example referencing FIG. 1, the target 160A identifies the port 150E, which is in the illustrated peer zone 190 and associated with the ports 150 of the peer zone 190.

In some examples, the target 160 identifies a port 150 in response to a fault event occurring within the SAN computing environment 100. The fault may correspond to a SAN device of the SAN computing environment 100 exceeding a threshold error count during a runtime operation and/or a parameter exceeding a preset range for the parameter. For an example with reference to FIG. 1, the SAN device at fault may correspond to the transceiver 152 of the switch 112 that directly connects to the identified port 150E of the target 160A. Such a fault may cause a component of the host 120A, such as the HBA 130, to exceed a threshold error count when sending communications to the identified target port 150E of the target 160A. In general, the fault may be associated with a transceiver 152 or any other suitable component of a SAN device of the SAN fabric 110, such as a port 150 or an interconnecting cable.

In some examples, the target 160 identifies a port 150 in response to an initialization event preceding a configuration occurring within the SAN computing environment 100. The initialization may correspond to an administrative or management change in the zoning of the SAN computing environment 100. For an example with reference to FIG. 1, an administrative change in the zoning may cause the configuration of peer zone 190 as illustrated on the SAN fabric 110. Such a configuration may be preceded by an initialization event that is communicated to the target 160A, causing it to identify its port 150E. Such initialization events may occur either during a runtime operation of the SAN and/or prior to a runtime, such as during a startup phase of the SAN.

Referring to block 206, the target 160A retrieves, from the switch 112, a set of peer zones 190 for which the identified port 150E of the target 160A is a principal member. The switch 112 may be the switch that connects the identified target port 150E to the SAN fabric 110. In several examples of SAN fabrics 110 and smart SAN fabrics 110 in particular, the switch 112 may store, in a non-transitory computer-readable storage medium such as a switch database, a set of peer zones 190 pursuant to which it exercises procedural control of routing and zoning over the SAN fabric 110. The target 160A may thereby retrieve the set of peer zones 190 for which the identified target port 150E is the principal member, without having direct communications with the hosts 120 of the set of peer zones 190. In an example with reference to FIG. 1, the identified target port 150E, which directly connects to the SAN fabric 110 via the port 150G of the switch 112, is a principal member for the set of peer zones 190 that includes the illustrated peer zone 190. The target 160A thereby retrieves the set of peer zones 190 for its identified target port 150E, including the illustrated peer zone 190, without directly communicating with the illustrated hosts 120 of the illustrated peer zone 190.

In block 208, the target 160A retrieves, from the switch 112, a set of end-device ports 150 associated with the retrieved set of peer zones 190. An end-device port 150 may include a port 150 of a host 120 or of a switch 112. As above in block 206, the switch 112 may be the switch that connects the identified target port 150E to the SAN fabric 110; it may be the same switch 112 as used in the process of block 206. In several examples of SAN fabrics 110 and smart SAN fabrics 110 in particular, the switch 112 may store, in a non-transitory computer-readable storage medium such as a switch database, a set of end-device ports 150 that are associated with the stored set of peer zones 190, pursuant to which it exercises procedural control of routing and zoning over the SAN fabric 110. The target 160A may thereby retrieve the set of end-device ports 150 that have permission to communicate with the identified target port 150E, without engaging in direct communications with the SAN devices other than the switch 112. In an example with reference to FIG. 1, the target 160A retrieves this port information from the switch 112 that directly connects the identified target port 150E to the SAN fabric 110 via the illustrated switch port 150. The target 160A communicates via the illustrated switch port 150 with the switch 112 and thereby retrieves the set of end-device ports 150 without engaging in direct communications with the other SAN devices, including the illustrated hosts 120, which are also associated with the set of ports 150.

In block 210, the SAN target 160A may determine a health status of a SAN port 150 of the retrieved set of end-device ports 150. The target 160A may determine the health status of a SAN port 150 based on a corresponding set of diagnostic parameters. The set of diagnostic parameters may vary with respect to the corresponding type of SAN device and/or suitable device component, such as for example the ports 150 and/or the transceivers 152. A diagnostic parameter may have a threshold error count and/or a preset range, pursuant to a preset rule of the SAN computing environment 100. In several examples, the SAN target 160A determines that a health status of a SAN port 150 is faulty when a corresponding diagnostic parameter exceeds a threshold error count and/or a preset range for the parameter. The SAN port 150 may be a SAN port 150 not directly connected to the SAN target 160A.

The set of diagnostic parameters corresponding to a SAN device and/or suitable device component may be retrieved by the target 160A from the switch 112. In several examples of SAN fabrics 110 and smart SAN fabrics 110 in particular, the switch 112 may include one or more utilities by which it may monitor, display, and/or retrieve one or more diagnostic parameters for a SAN device and/or suitable device component, pursuant to its exercise of procedural control of routing, zoning, management, and/or other suitable administration of the SAN fabric 110. The switch 112 used in this process may be the same as the switch used in the processes described above for block 206 and/or for block 208. As above in block 206 and/or block 208, the switch 112 may be the switch that directly connects the identified target port 150E to the SAN fabric 110; it may be the same switch 112 as used in the processes of block 206 and/or block 208.

The method 200 ends in block 250.

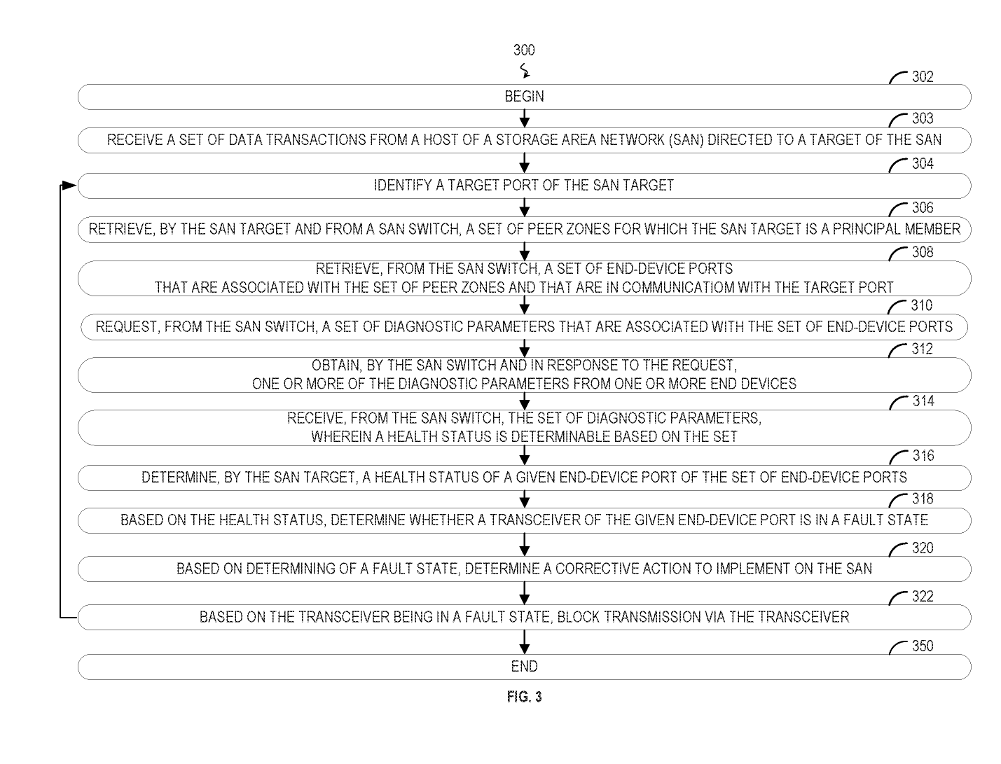

Further examples are described in further detail with reference to FIG. 3. In that regard, FIG. 3 is a flow diagram of a method 300 of detecting a failing transceiver 152 of a SAN port 150 by a SAN target 160, according to some examples of the present disclosure. As noted with respect to method 200 of FIG. 2, it is understood that the description of method 300 is non-limiting, that steps may be added to and omitted from the method 300 without departing from the disclosure, and that processes of the method 300 may be performed in any order or manner including concurrently by one or more entities. In general, the method 300 is equally suitable for performance using the SAN computing environment 100 of FIG. 1, or any other suitable computing environment.

Method 300 begins in block 302. In block 303, a SAN target 160 may receive a set of data transactions from a SAN host 120 directed to the SAN target 160. For an example with reference to FIG. 1, the target 160A receives a set of data transactions from the host 120A, which routes through a SAN path of the illustrated peer zone 190, including the switch 112 and at least its two switch ports 150 that connect the sending host port 150A and the receiving target port 150E, respectively, to the SAN fabric 110. The SAN target 160A may then proceed through one or more of the processes of the blocks 304 through blocks 322 of the method 300 while processing the set of data transactions received from the SAN host 120A; it may process these data in parallel.

Blocks 304, 306, and 308 of the method 300 may involve processes that are each substantially similar to that of the corresponding blocks 204, 206, and 208, respectively, of the method 200. Referring to block 304, the SAN target 160A identifies a target port 150 of the SAN target 160A. This may be performed substantially as described in block 204 of FIG. 2. Referring to block 306, the SAN target 160A retrieves from the SAN switch 112 a set of end-device ports 150 that are associated with the set of peer zones 190 and that are in communication with the target port 150E. This may be performed substantially as described in block 206 of FIG. 2. Referring to block 308, the SAN target 160A retrieves from the SAN switch 112 a set of end-device ports 150 that are associated with the set of peer zones 190 and that are in communication with the target port 150E. This may be performed substantially as described in block 208 of FIG. 2.

In block 310, the SAN target 160A requests from the switch 112 a set of diagnostic parameters, based on which the target 160A may determine the health status of a SAN port. A diagnostic parameter may provide any suitable data and/or information based on which a health status may be determined. For example, diagnostic parameters for the ports 150 may include a port link failure count, a port loss of signal count, a flag, and/or any other suitable characteristic of the ports 150. Similarly, the set of diagnostic parameters may include one or more corresponding component devices, such as the transceivers 152. For example, diagnostic parameters for the transceivers 152 may include a temperature, a supply voltage, a transmission power (or receiver power), a transmission output power (or transmitter power), a transmit bias, a flag, and/or any other suitable characteristic of the transceivers 152. In some such examples, the transceivers 152 include one or more SFP transceivers. In several examples of the present disclosure, the set of diagnostic parameters corresponding to the transceivers 152, including suitable SFP transceivers, includes diagnostic parameters that are provided and/or otherwise made available through a suitable diagnostic digital monitoring (DDM) utility designed for network management of a SAN, such as the Diagnostic Monitoring Interface for Optical Transceivers (DMIOT).

As noted above with reference to block 210, in several examples of SAN fabrics 110 and smart SAN fabrics 110 in particular, the switch 112 may include one or more utilities by which it monitors, displays, and/or retrieves one or more diagnostic parameters for a SAN device and/or suitable device component, pursuant to its exercise of procedural control of routing, zoning, management, and/or other suitable administration of the SAN fabric 110. As above for block 206 and/or block 208 and thus similarly in block 306 and/or block 308, the switch 112 may be the switch that connects the identified target port 150E to the SAN fabric 110; it may be the same switch 112 as used in the processes of block 306 and/or block 308. As noted with block 210, the set of diagnostic parameters may vary with respect to the corresponding type of SAN device and/or suitable device component, and pursuant to preset rules of the SAN computing environment 100. For example, diagnostic parameters for the ports 150 may include the port link failure count port loss of signal count, flags, and others as noted above, whereas diagnostic parameters for the transceivers 152 may include the temperature, the supply voltage, the transmission power (or receiver power), transmission output power (or transmitter power), transmit bias, flags, and others as noted above. Similarly, diagnostic parameters may vary between types of transceivers, such as SFP transceivers and others, and based on providing utilities, such as DMIOT as described above.

In block 312, the switch 112 may obtain one or more of the diagnostic parameters from one or more end devices, such as the host 120A. Each end device thus polled may correspond to one or more of the end-device ports 150 and/or suitable device components, such as the host 120A corresponds to the host ports 150A and 150B. As noted above, such an end device may correspond to any SAN device, such as a host 120, target 160, or switch 112. The switch 112 may send one or more command requests and receive one or more command responses in performance of the polling process. In this manner, the switch 112 may obtain newly polled diagnostic parameters, rather than retrieving them from a store.

In block 314, the SAN target 160A receives from the switch 112 the set of diagnostic parameters, based on which the target 160A may determine the health status of a SAN port 150. The received set of diagnostic parameters may be the same as the requested set, as described in block 310 above. The received set of diagnostic parameters may include one or more parameters as newly polled by the switch 112, as described in block 312 above.

In block 316, the SAN target 160A determines a health status of a given end-device port 150 of the set of end-device ports 150. The health status of a port 150 may be determined to be healthy or faulty, based on the corresponding set of diagnostic parameters that the target 160A receives from the switch 112 for the port 150, as described in block 314 above. The given end-device port 150 may not be directly connected with the identified target port 150E. This may be performed substantially as described in block 210 of FIG. 2.

In block 318, the target 160A determines that a transceiver 152 that corresponds to an end-device port 150 is in a fault state. In several examples of a SAN computing environment 100 including in a smart SAN fabric 110, a one-to-one correspondence of the transceiver 152 to a port 150 may provide as a result that the port 150 is also in a fault state. The target 160A may base the determination on the corresponding set of diagnostic parameters that are received as described in block 314 above and/or that are newly polled as described in block 312 above. As also noted above, a fault state may correspond to a diagnostic parameter of the transceiver 152 exceeding a threshold error court and/or a preset range for the parameter, pursuant to a preset rule of the SAN computing environment 100. In some examples, the received set of diagnostic parameters of the transceiver 152 includes a temperature parameter that exceeds a preset range for that parameter, such that the transceiver 152 is in a fault state because it is too hot. In some examples, the received set of diagnostic parameters of the transceiver 152 includes a supply voltage parameter that is below a preset range for that parameter, such that the transceiver 152 is in a fault state because it is insufficiently supplied with electrical power. In some examples, the received set of diagnostic parameters of the transceiver 152 includes a flag parameter that exceeds a preset count for that parameter, such that the transceiver is in a fault state because it is thus flagged pursuant to a predetermined or threshold error count. Analogous examples may apply for each of the diagnostic parameters of the transceiver 318 and/or other suitable parameters.

In block 320, the target 160A determines a corrective action to take with respect to determining that a port 150 and/or its corresponding transceiver 152 is in a fault state. A corrective action may include and/or result in blocking transmission via the corresponding transceiver 152. The target 160A may communicate with the switch 112 to implement the corrective action, including such a blocking of transmission. As above in block 206 and/or block 208 and thus similarly in block 306 and/or block 308, the switch 112 may be the switch that connects the identified target port 150E to the SAN fabric 110; it may be the same switch 112 as used in the processes of block 306 and/or block 308. In several examples of SAN computing environments 100 and in particular in smart SAN fabrics 110, the switch 112 may include one or more utilities by which it enables and/or to disables a particular feature or runtime operation of a port 150, including blocking transmission via a transceiver 152 of a SAN device and/or suitable device component, pursuant to its exercise of procedural control of routing, zoning, management, and/or other suitable administration of the SAN fabric 110.

In some examples, the SAN target 160A acts to disable a port feature or runtime operation of the port 150 in a fault state. This disabling may block one or more SAN paths between a host 120 and a target 160 of the SAN fabric 110. The disabling may also block relevant transmission via the corresponding transceiver 152 with respect to the target 160A. This blocking of the transceiver 152 may result without regard to zoning of the SAN fabric 110 continuing to allow permission to communicate between respective SAN devices.

In some examples, the SAN target 160A acts to change the zoning of the SAN fabric 110 with respect to the port 150 in a fault state. This zoning change may de-zone the port 150 from one or more zones 190, such that the port 150 is no longer in the one or more zones 190. This zoning change may also block relevant transmission via the corresponding transceiver 152 with respect to the SAN target 160A. This blocking of the transceiver 152 may result without regard to continuing a runtime operation of the port 150.

In block 322, the SAN target 160A acts to block transmission via a transceiver 152 in a fault state. The SAN target 160A may block transmission as a result of one of the various corrective actions it may take, as described in block 320 above. The SAN target 160A may also act to block transmission directly. For example, the SAN target 160A may determine that the transceiver 152 is in a fault state and acts to block the transceiver 152 by disabling the relevant port feature of the corresponding port 150. In several examples of the present disclosure, blocking of transmission via the transceiver 152 in a fault state results in the transceiver 152 and/or the corresponding port 150 no longer having ability and/or permission to communicate with the target 160A and/or other targets 160 of the SAN fabric 110.

When a target 160 includes more than one target port 150, it may repeat one or more of blocks 304 through blocks 322 for each target port 150 of the target 160. By such repetition, the target 160 may determine the health status of each SAN port 150 of the set of SAN ports 150 that have permission to communicate with the target 160 via any of its several target ports 150. For example with reference to FIG. 1, the target 160A repeats blocks 304 through 318 for its target port 150F, which is not within the illustrated peer zone 190. The target 160A may thereby proceed in the manner as described above to determine the health status of a SAN port 150 of a new set of ports 150, i.e. those associated with target port 150F via its set of peer zones 190. A target 160 may continue such repetition over all of its target ports 150, or it may end such repetition in response to determining that a health status of a SAN port 150 is faulty. The method 300 ends in block 350.

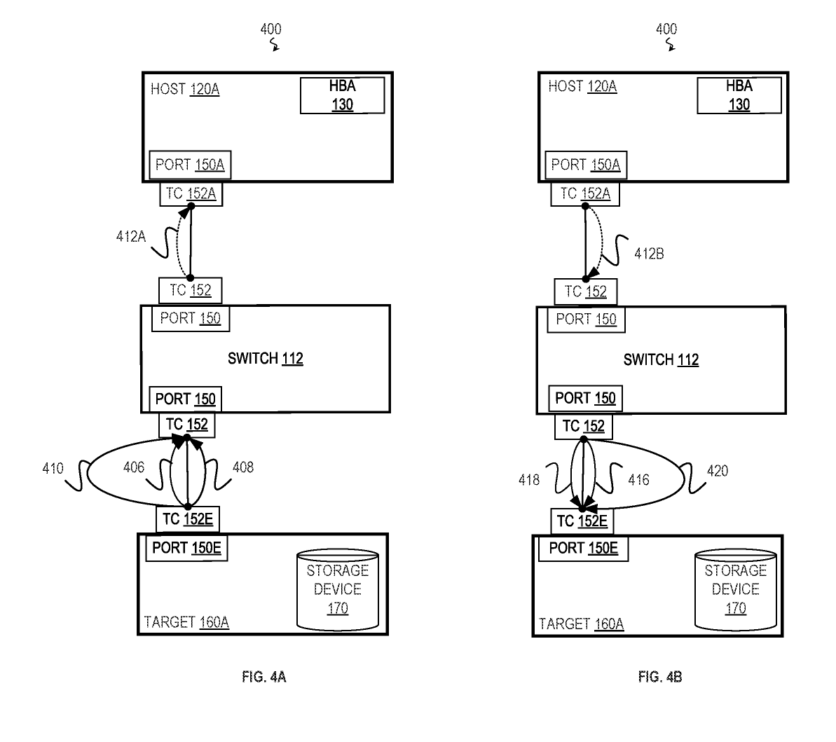

FIGS. 4A-4B are block diagrams of a computing environment 400 performing a method of determining a health status, according to some examples of the present disclosure. The computing environment 400 may be substantially similar to the computing environment 100, including with respect to the target 160A, the switch 112, and the host 120A of FIG. 1. As noted above, as the method 300 of FIG. 3 and in particular blocks 304, 306, 308, and/or 316 of the method 300 may involve processes that are each substantially similar to those of the corresponding blocks 204, 206, 208, and/or 210 of the method 200 of FIG. 2, so the block diagrams of FIGS. 4A-4B are equally suitable for performing the method 200 of FIG. 2. In some examples with reference to FIG. 3, the arrows of FIGS. 4A-4B illustrate the communication flow pathways between the ports 150, during a performance of the method 200 and/or the method 300 by the target 160A and the switch 112 of FIG. 1. In general, such communication flow pathways may include one or more command requests as in FIG. 4A and one or more command responses as in FIG. 4B. The communication flow pathways may involve one or more end devices, including one or more targets 160, switches 112 and/or hosts 120; FIGS. 4A-4B merely illustrate representative pathways. The switch 112 may be directly connected to the target 160A via the identified target port 150E, for example as illustrated. The end-device port 150A for which a health status is determined may not be directly connected to the identified target port 150E, for example as illustrated. Communications may be performed in any suitable order, including omission and/or addition.

By reference to FIG. 4A, the target 160A may send to the switch 112 one or more command requests via the arrow 406, as is described in performing the processes of block 206 of FIG. 2 and/or block 306 of FIG. 3. Similarly, the target 160A may send to the switch 112 one or more command requests via the arrow 408, as is described in performing the processes of block 208 of FIG. 2 and/or block 308 of FIG. 3. Similarly, the target 160A may send to the switch 112 one or more command requests via the arrow 410, as is described in performing the process of block 310 of FIG. 3. In response to a request from the target 160A, as via the arrow 410, the switch 112 may send to one or more end devices such as the host 120A one or more polling requests via arrows such as the arrow 412A for one or more of the diagnostic parameters, as described in performing the process of block 312 of FIG. 3.

By reference to FIG. 4B, the switch 112 may send to the target 160A one or more command responses via the arrow 416, as is described in performing the processes of block 206 of FIG. 2 and/or block 306 of FIG. 3. Similarly, the switch 112 may send to the target 160A one or more command responses via the arrow 418, as is described in performing the processes of block 208 of FIG. 2 and/or block 308 of FIG. 3. Similarly, the switch 112 may send to the target 160A one or more command responses via the arrow 420, as is described in performing the process of block 314 of FIG. 3. The host 120A may also respond to the polling request of the switch 112 by polling anew the requested set of diagnostic parameters prior to sending these parameters to the switch 112 via the arrow 412B, as is described in performing the process of block 312 of FIG. 3. The switch 112 may await the one or more polling responses from the one or more end devices such as the host 120A via arrows such as the arrow 412B prior to sending in response to the target 160A one or more command returns via the arrow 420, as described in performing the process of block 314 of FIG. 3. The switch 112 may aggregate the one or more polling responses into a poll set prior to sending in response to the target 160A one or more command returns via the arrow 420.

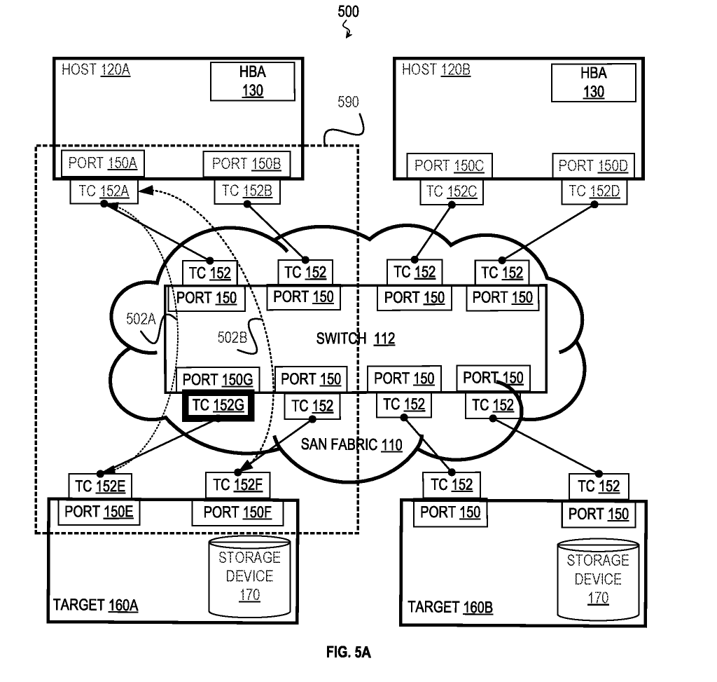

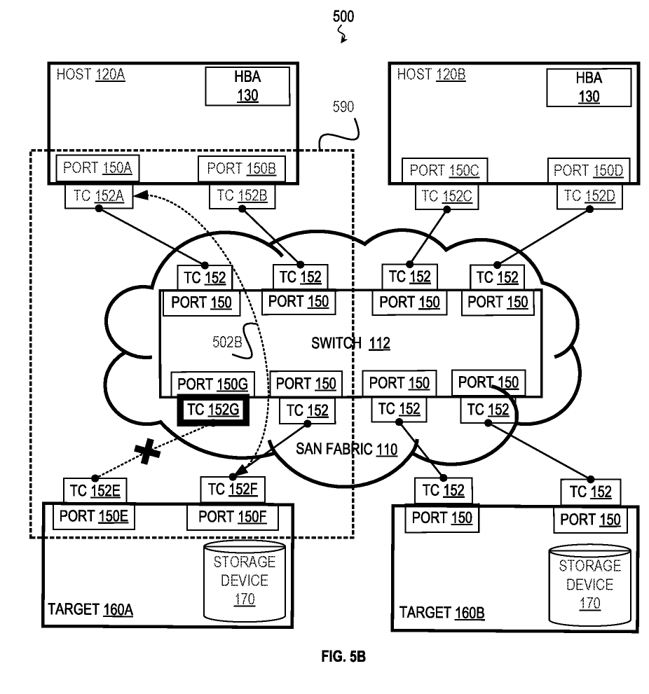

FIGS. 5A-5B are block diagrams of a computing environment 500 performing a method of detecting a failing transceiver 152G, according to some examples of the present disclosure. In many aspects, the SAN computing environment 500 may be substantially similar to the SAN computing environment 100 of FIG. 1. Specifically, the SAN fabric 110, switch 112, hosts 120, HBAs 130, ports 150, transceivers 152, targets 160, and storage devices 170 may each be substantially similar to those of the same name and reference number as illustrated in FIG. 1 and as described above. Thus, the methods 200 and/or 300 are equally suitable for performance using the SAN computing environment 500 of FIGS. 5A and 5B, the SAN computing environment 100 of FIG. 1, or any suitable computing environment.

The illustrated peer zone 590 of FIGS. 5A-5B includes both of the target ports 150E and 150F of the target 160A. Thus, the host 120A of the peer zone 590 may communicate with the target 160A via either of its target ports 150. For example, the host port 150A of the host 120A may communicate with the target 160A over the SAN path 502A via the target port 150E and/or the SAN path 502B via the target port 150F. Each SAN path 502 routes through the switch 112 and at least the two switch ports 150 that directly connect the respective host port 150 and the respective target port 150 to the SAN fabric 110. In FIG. 5A, the target 160A may perform the method 300 to determine a health status of a SAN port 150. In an example, in performance of the method 300, the target 160A determines, as in block 316, that a transceiver 152G of the transceivers 152 corresponding to the set of end-device ports 150 is in a fault state. In several examples, the target 160A determines a corrective action and then blocks the transceiver 152G, as described with reference to block 318 of FIG. 3, such that the transceiver 152G no longer routes data and/or other in-band management traffic to the target port 150A of the target 160A. With reference to FIG. 5B, this blocking of transmission is illustrated by a cross on the coupling line between the transceivers 152E and 152G. For example with respect to FIG. 5B, the host port 150A of the host 120A may continue to communicate with the target 160A over the SAN path 502B via its target port 150F; however, the host port 150A may no longer communicate over the SAN path 502 via the target port 160E, as had previously been possible and illustrated in FIG. 5A. Thus, the target 160A performed a method to diagnose and isolate the transceiver 152G in a fault state.

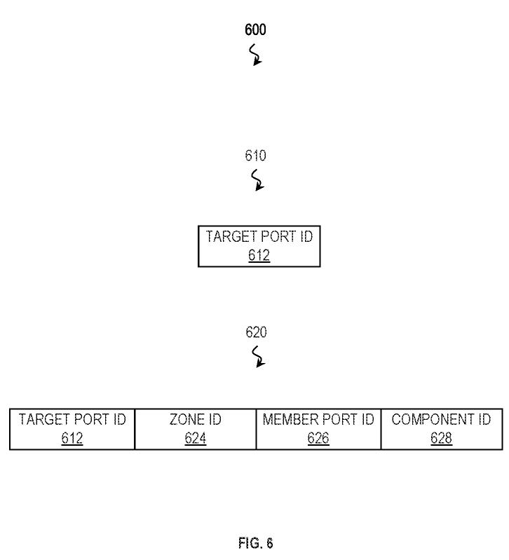

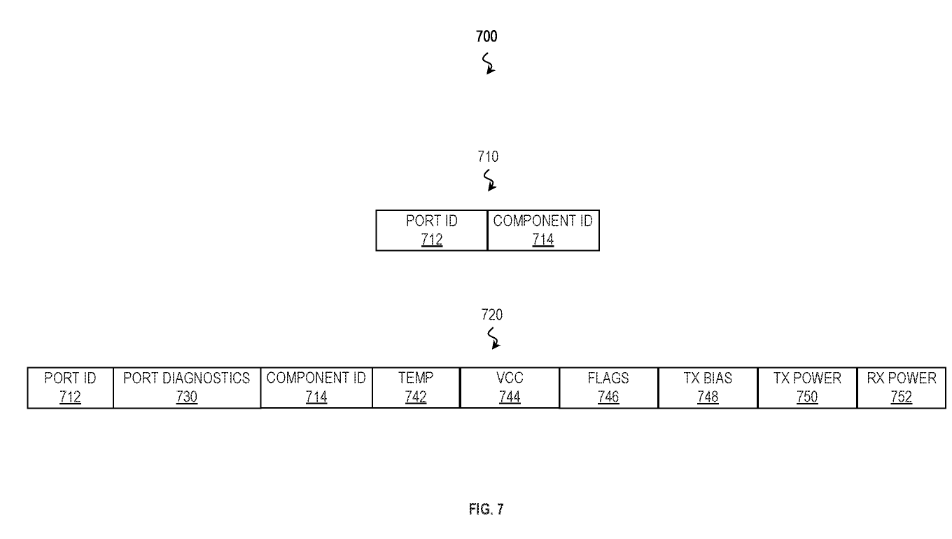

FIGS. 6-7 are diagrams of SAN commands 600 and 700, according to some examples of the present disclosure. The commands 600 and 700 are suitable for use in the SAN computing environment 100 of FIG. 1, the SAN computing environment 500 of FIGS. 5A and 5B, and/or any other suitable computing environment; in the examples of FIGS. 1, 2, 3, 4A-4B, and/or 5A-5B; and/or in performing several of the processes of method 200 of FIG. 2 and/or method 300 of FIG. 3. The commands 600 and/or 700 may be performed by any combination of hard-coded and programmable logic in a processing resource. Furthermore, the commands 600 and/or 700 may include the illustrated identifiers (IDs) in any form or combination, including omission or addition.

With reference to FIGS. 4A-4B and the various communications described above in the processes of the method 200 and/or the method 300, the target 160A may communicate with the switch 112 by sending one or more commands via in-band management traffic directly to the switch 112. FIG. 6 diagrams the SAN command 600, including a command request 610 to send IDs as via the pathway of arrows 406 and/or 408 of FIG. 4A, and a command return 620 to receive IDs as via the pathway of arrows 416 and/or 418 of FIG. 4B. The SAN command 600 may provide for the target 160A to retrieve from the switch 112 zoning information for the identified target port 150E, as described in blocks 206 and/or 208 of FIG. 2 and/or blocks 306 and/or 308 of FIG. 3. Similarly, FIG. 7 diagrams the SAN command 700, including a command request 710 to send IDs as via the pathway of arrow 410 of FIG. 4A and a command return 720 to receive IDs as via the pathway of arrow 420 of FIG. 4B. The SAN command 700 may provide for the target 160A to retrieve from the switch 112 a set of diagnostic parameters, as described in blocks 310, 312, and/or 314 of FIG. 3.

FIG. 6 diagrams the SAN command 600, which may be referred to as a Get Diagnostic Devices List (GDDL) command. The GDDL command 600 is an example of a class of commands that request the switch 112 to return zoning information. The GDDL command request 610 may be sent by the target 160A to the switch 112, such that the switch 112 command response 620 returns to the target 160A the relevant zoning information. The GDDL command request 610 may include a target port ID 612, such as the WWPN of the target port 150E that the target 160A has identified, as described in block 304. The GDDL command request 610 may cause the switch 112 to send to the target 160A a command response 620. The GDDL command response 620 may again include the target port ID 612, a zone ID 624, providing the set of peer zones 190 for which the identified target port 150A is the principal member, as described in block 306, and a member port ID 626, providing the set of end-device ports 150 associated with the set of peer zones 190, such as by their WWPN, as described in block 308. The GDDL command return 620 may also include a component ID 628 for each of the relevant end-device ports 150, such as for the component transceivers 152, as described in block 308. As noted above, an end-device port 150 may be a port 150 of any SAN device, including a switch 112 or a host 120. In several examples of a SAN computing environment 100 and in particular a smart SAN fabric 110, some such component transceivers 152 may include suitable SFP transceivers 152 or any other suitable transceivers 152.

In some examples with reference to FIGS. 4A-4B, the target 160A sends the GDDL command request 610 in the process of performing block 306 and/or block 308 of the method 300 of FIG. 3. The target 160A sends to the switch 112 the GDDL command request 610 via the flow pathway of arrows 406 and/or 408 of FIG. 4A. The switch 112 responds to the target 160A with the command return 620 via the flow pathway of arrows 416 and/or 418 of FIG. 4B. The GDDL command request 610 thus causes the switch 112 to return to the target 160A zoning information including IDs for the set of peer zones 190, as described in block 306 of FIG. 3, and IDs for the member ports 150 of the set of peer zones 190, as described in block 308 of FIG. 3. The GDDL command return 620 may also include a component ID 628 for suitable components of the relevant end-device ports 150, including for example any corresponding transceivers 152. The target 160A may both send to the switch 112 the GDDL command request 610 as via arrows 406 and/or 408 of FIG. 4A and receive from the switch 112 the GDDL command return 620 as via arrows 416 and/or 418 of FIG. 4B by using in-band management traffic. Thus, the target 160A may also process a set of data transactions and/or other in-band traffic that was received from a host 120 while performing the method 200 and/or 300 in such manner, as indicated in block 303 of FIG. 3.

FIG. 7 diagrams the SAN command 700, which may be referred to as an Analyze Device Path (ADP) command. The ADP command 700 is an example of a class of commands that request the switch 112 to return a set of diagnostic parameters. The ADP command request 710 may be sent by the target 160A to the switch 112, such that the switch 112 command response 720 returns to the target 160A the requested set of diagnostic parameters. The ADP command request 710 may include port IDs 712, providing an identifier such as a WWPN for each end-device port 150 for which diagnostic parameters are requested. The port ID 712 may include a component ID 714, providing an identifier for relevant port components such as the transceivers 152. In several examples of performing the method 300, the ADP command field 710 may include the port IDs that the target 160A received from the GDDL command return 620. The ADP command return 720 may include the port ID 712 and the component ID 714, as well as suitable diagnostics that vary by port 150 and/or device component, based on parameter availability and pursuant to preset rules of the SAN computing environment 100, such as described above with reference to block 310 of FIG. 3. For example, a port diagnostics ID 730 may include diagnostic parameters for the ports 150, such as a port link failure count, a port loss of signal, a flag, and/or any other suitable characteristics of a port 150. For example, diagnostic parameters for a component ID 714 may include those of the corresponding transceivers 152: a temperature 742, supply voltage (Vcc) 744, flag 746, transmit bias (Tx bias) 748, transmission power (Rx power, or receiver power) 750, transmission output power (Tx power, or transmitter power) 752, and any other suitable characteristics of suitable such component transceivers 152. In some such examples, the transceivers 152 may include one or more SFP transceivers.

In some examples with reference to FIGS. 4A-4B, the target 160A sends the ADP command request 710 in the processes of performing blocks 310 and/or 312 of the method 300 of FIG. 3. The target 160A sends to the switch 112 the ADP command request 710 as via the arrow 410 of FIG. 4A. The switch 112 responds to the target 160A with the ADP command return 720 as via the arrow 420 of FIG. 4B. The ADP command request 710 thus causes the switch 112 to return to the target 160A the set of diagnostic parameters for the requested set of end-device ports 150, as described in blocks 310 and 314 of FIG. 3. The ADP command request 710 may also cause the switch 112 to send one or more polling requests in response as via arrow 412A of FIG. 4A and to receive one or more polling responses as via arrow 412B of FIG. 4B, as described in block 312 of FIG. 3. The target 160A may both send to the switch 112 the ADP command request 710 as via arrow 410 and receive from the switch 112 the ADP command return 720 as via arrow 420 by using in-band management traffic. Thus, the target 160A may also process a set of data transactions and/or other in-band traffic that was received from a host 120 while performing the method 300 in this manner, as indicated in block 303 of FIG. 3.

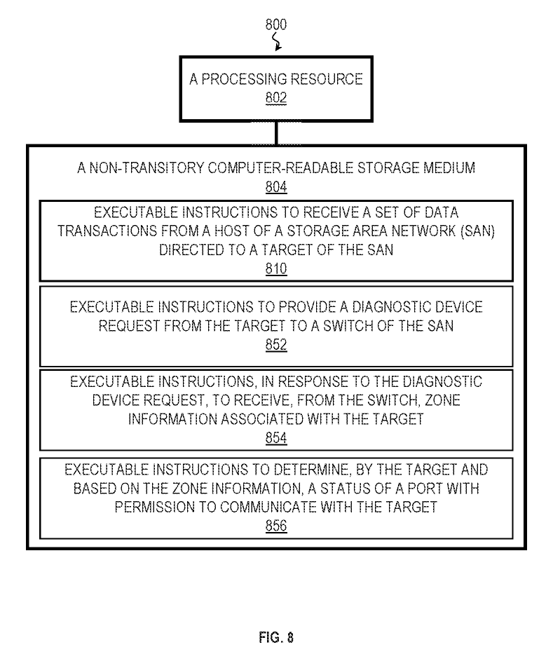

Examples of a medium for use in performing the processes of method 200 and/or 300 are described in further detail in the context of FIG. 8. In that regard, FIG. 8 is a block diagram of a system 800 including a processing resource 802 and a non-transitory computer-readable storage medium 804, according to some examples of the present disclosure. The processing resource 802 may correspond to a processing resource of the target 160A, and the storage medium 804 may correspond to a storage medium of the target 160A. Thus, the medium is suitable for use in the examples of FIGS. 1, 2, 3, 4A-4B, and 5A-5B and may perform any of the processes of method 200 of FIG. 2 and/or method 300 of FIG. 3. The processes of methods 200 and/or 300 may be performed by any combination of hard-coded and programmable logic in the processing resource 802. The processing resource 802 may furthermore perform the processing of the commands 600 and/or 700 of FIGS. 6-7.

Referring to block 810, the non-transitory computer-readable memory resource 804 may store instructions that cause the processing resource 802 to receive a set of data transactions from a host 120. This may be performed substantially as described for block 303 of FIG. 3.

Referring to block 852, the non-transitory computer-readable medium 804 may store instructions that cause the processing resource 802 to provide a diagnostic device request from the target 160A to the switch 112 of the SAN. This may be performed substantially as described for blocks 206 and/or 208 of FIG. 2 and/or blocks 306, 308, and/or 310 of FIG. 3 and as via arrows 406 and 408 of FIG. 4A.

Referring to block 854, the non-transitory computer-readable medium 804 may store instructions that cause the processing resource 802 to receive from the switch 112 zone information associated with the target 160A. This may be performed substantially as described for blocks 206 and/or 208 of FIG. 2 and/or blocks 306, 308, and/or 314 of FIG. 3 and as via arrows 416 and 418 of FIG. 4B.

Referring to block 856, the non-transitory computer-readable medium 804 may store instructions that cause the processing resource 802 to determine by the target 160 and based on the zone information, a status of a port 150 with permission to communicate with the target 160. This may be performed substantially as described for block 210 of FIG. 2 and/or block 316 of FIG. 3.

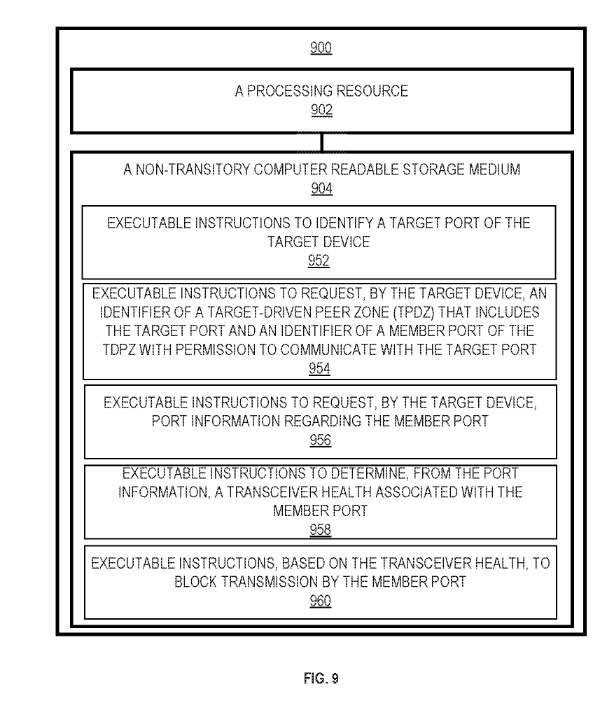

Examples of a device for use in performing the processes of method 200 and/or 300 are described in further detail in the context of FIG. 9. In that regard, FIG. 9 is a block diagram of a SAN target 900 including a computer-readable storage medium 904 containing executable instructions, according to some examples of the present disclosure. The SAN target 900 may be substantially similar to the target 160A; the non-transitory computer-readable medium 904 may be substantially similar to the non-transitory computer-readable medium 804, and the processing resource 902 may be substantially similar to the processing resource 802. Thus, the SAN target 900 is suitable for use in the examples of FIGS. 1, 2, 3, 4A-4B, and 5A-5B and may perform any of the processes of method 200 of FIG. 2 and/or method 300 of FIG. 3 as well as any of the executable instructions of the medium of FIG. 8. The processes of methods 200 and/or 300, as well as the executable instructions of the medium of FIG. 8, may be performed by any combination of hard-coded and programmable logic in the processing resource 902. The processing resource 902 may furthermore perform the processing of the commands 600 and/or 700 of FIGS. 6-7.

Referring to block 952, the non-transitory computer-readable medium 904 may store instructions that cause the processing resource 902 to identify a target port 150 of the SAN target 900. This may be performed substantially as described with respect to block 204 of FIG. 2 and/or block 304 of FIG. 3.

Referring to block 954, the non-transitory computer-readable medium 904 may store instructions that cause the processing resource 902 to request by the SAN target 900 an identifier of a target-driven peer zone 190 that includes the target port 150 and an identifier of a member port 150 of the target-driven peer zone 190 with permission to communicate with the target port 150. This may be performed substantially as described with respect to blocks 206 and/or 208 of FIG. 2 and/or blocks 306 and/or 308 of FIG. 3 and as via arrows 406 and/or 408 of FIG. 4A.

Referring to block 956, the non-transitory computer-readable medium 904 may store instructions that cause the processing resource 902 to request by the SAN target 900 port information regarding the member port 150. This may be performed substantially as described with respect to block 310 of FIG. 3 and as via arrow 410 of FIG. 4A.

Referring to block 958, the non-transitory computer-readable medium 904 may store instructions that cause the processing resource 902 to determine, from the port information, a transceiver health associated with the member port 150. This may be performed substantially as described with respect to block 210 of FIG. 2 and/or block 316 and/or block 318 of FIG. 3.

Referring to block 960, the non-transitory computer-readable medium 904 may store instructions that cause the processing resource 902 to block transmission by the member port. This may be performed substantially as described with respect to blocks 320 and/or 322 of FIG. 3 and as with reference to the illustrations of FIGS. 5A-5B.

In examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof. In examples described herein, at least one processing resource may fetch, decode, and execute instructions stored on a storage medium to perform functionalities described above in relation to instructions stored on a storage medium. In other examples, the functionalities of any of the instructions may be implemented in the form of electronic circuitry, in the form of executable instructions encoded on a machine-readable storage medium, or a combination thereof. As used herein, a “computer-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any computer-readable storage medium described herein may be non-transitory. In examples described herein, a computer-readable storage medium or media may be part of an article (or article of manufacture). An article or article of manufacture may refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
identifying a target port of a storage area network (SAN) target;
retrieving, by the SAN target and from a SAN switch, a set of peer zones for which the SAN target is a principle member;
retrieving, from the SAN switch, a set of end-device ports that are associated with the set of peer zones and that are in communication with the target port; and
determining, by the SAN target, a health status of a given end-device port of the set of end-device ports.

2. The method of claim 1, wherein the given end-device port is a port of a SAN host.

3. The method of claim 1, wherein the given end-device port is a port of a SAN switch.

4. The method of claim 1, comprising retrieving, from the SAN switch, a diagnostic parameter including one of a temperature, a supply voltage, a transmit bias, a transmitter power, a receiver power, or a system flag, wherein the health status is determined based on the diagnostic parameter.

5. The method of claim 4, wherein the diagnostic parameter and the health status are associated with a transceiver of the given end-device port.

6. The method of claim 4, wherein the SAN switch polls the diagnostic parameter in response to a request from the SAN target.

7. The method of claim 1, comprising:
based on the health status, determining whether a transceiver of the given end-device port is in a fault state, and
based on the transceiver being in the fault state, blocking transmission via the transceiver.

8. The method of claim 1, wherein the given end-device port is not directly connected to the target port.

9. A non-transitory computer-readable storage medium comprising a set of executable instructions that, when executed, cause a processing resource to:
receive a set of data transactions from a host of a storage area network (SAN) directed to a target of the SAN;
while the target processes the set of data transactions:
provide a diagnostic device request from the target to a switch of the SAN;
receive, from the switch, zone information associated with the target in response to the diagnostic device request; and
determine, by the target and based on the zone information, a status of a port with permission to communicate with the target.

10. The non-transitory computer-readable storage medium of claim 9 including thereon instructions that, when executed, cause the processing resource to:
provide a path analysis request from the target to the switch based on the zone information; and
in response to the path analysis request, receive, from the switch, a health parameter of a transceiver of the port, wherein the status of the port is determined based on the health parameter.

11. The non-transitory computer-readable storage medium of claim 10 including thereon instructions that, when executed, cause the processing resource to:
determine from the health parameter whether the transceiver fails an integrity threshold; and
when the transceiver fails the integrity threshold, block transmission over the transceiver.

12. The non-transitory computer-readable storage medium of claim 10, wherein the health parameter includes a characteristic selected from a group consisting of: a temperature, a supply voltage, a transmit bias, a transmitter power, a receiver power, and a system flag.

13. The non-transitory computer-readable storage medium of claim 10, wherein the health parameter is polled from an end device corresponding to the transceiver in response to the path analysis request.

14. The non-transitory computer-readable storage medium of claim 9, wherein the zone information associated with the target includes:
an identifier of a target-driven peer zone associated with the target; and
an identifier of a member port of the target-driven peer zone.

15. A target device of a storage area network (SAN) comprising:
a processing resource;
a non-transitory computer-readable storage medium containing thereon a set of executable instructions that, when executed, cause the processing resource to:
identify a target port of a the target device;
request, by the target device, an identifier of a target-driven peer zone that includes the target port and an identifier of a member port of the target-driven peer zone with permission to communicate with the target port;
request, by the target device, port information regarding the member port;
determine, from the port information, a transceiver health associated with the member port; and
based on the transceiver health, block transmission by the member port.

16. The non-transitory computer-readable storage medium of claim 15, wherein the request of the identifier of the target-driven peer zone and the request of the port information are performed in response to a target-driven peer zone configuration.

17. The non-transitory computer-readable storage medium of claim 15, wherein the request of the identifier of the target-driven peer zone and the request of the port information are performed in response to a SAN fabric fault.

18. The non-transitory computer-readable storage medium of claim 15, wherein the member port is associated with a member from a group consisting of: a SAN host and a SAN switch.

19. The non-transitory computer-readable storage medium of claim 15, wherein the member port is not directly connected to the target port.

20. The non-transitory computer-readable storage medium of claim 15, wherein the request of the identifier of the target-driven peer zone, the request of the port information, and the determination of the transceiver health are each performed by the target during processing of a set of data transactions by the target.
